(19) United States
(12) Patent Application Publication
(10) Pub. No.: US 2010/0100599 A1
(43) Pub. Date: Apr. 22, 2010

(54) Mass Email and Text Message Text Individualization and Email and Text Message Private Commenting

(76) Inventor: Nathan J. Witzany, Maple Grove, MN (US)

Correspondence Address: Nathan J. Witzany, 9179 Larch Ln. N, Maple Grove, MN, 55369, US

(21) Appl. No.: 12/576,997

(22) Filed: Oct. 9, 2009

Related U.S. Application Data
(60) Provisional application No. 61/104,721, filed on Oct. 11, 2008.

(51) Int. Cl. G06F 15/16

(52) U.S. Cl. 709/206

(57) ABSTRACT

The present disclosure relates to novel and advantageous systems and methods for email, text messages, and the like, and particularly relates to systems and methods for email and text message text individualization and private commenting. More particularly, the present disclosure relates to novel and advantageous systems and methods for email and text message text individualization and private commenting, wherein text of a single email or text message can be directed to, personalized for, specialized for, or otherwise individualized for each recipient.

### FIELD OF THE INVENTION

The present disclosure relates to email, text messages, and the like, and particularly relates to mass email and text message text individualization and email and text message private commenting. More particularly, the present disclosure relates to mass email and text message text individualization and email and text message private commenting, wherein text of a mass email or text message can be directed to, personalized for, specialized for, or otherwise individualized for each recipient.

### BACKGROUND OF THE INVENTION

Emails and text messages have become a dominant form of communication. Oftentimes, it may be desirable to create or forward an email or text message to one or more recipients (e.g., mass email or text message). Presently, the same contents of the email or text is sent to each recipient on each of the “to,” “cc,” and “bcc” address lines. The only manner in which an individualized email or text can be sent to each addressee or a subset of all addressees is to send or forward a separate email to each addressee or subset of addressees.

Additionally, it may oftentimes be desirable to add a comment or remark to an email or text, the comment being directed to the recipient or recipients. However, in many instances, it may not be desirable for the comment or remark to remain or become part of the forwarded email or text or otherwise become part of any saved record due to privacy concerns. Presently, there is no easy and simple manner in which an email or text may be created for or forwarded to a recipient or recipients wherein a comment or remark directed to the recipient or recipients of the forwarded message does not become part of the forwarded message, and particularly wherein the comment or remark does not generally become part of any record, particularly where the sender can control whether the comment or remark is allowed to become part of any record.

### BRIEF SUMMARY OF THE INVENTION

The present disclosure, in one embodiment, relates to a system for mass email or text message text individualization. The present disclosure, in another embodiment, relates to a method for mass email or text message text individualization. The present disclosure, in yet a further embodiment, relates to a system for email or text message private commenting. The present disclosure, in still another embodiment, relates to a method for email or text message private commenting.

While multiple embodiments are disclosed, still other embodiments of the present disclosure will become apparent to those skilled in the art from the following detailed description, which shows and describes various illustrative embodiments. As will be realized, the embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 illustrates an example of a suitable computing system operating environment in which the various embodiments of the present disclosure may be implemented.

FIG. 2 illustrates an example of a suitable computing system for implementing the various aspects of the embodiments of the present disclosure.

FIG. 3 is an illustrative embodiment of a system for email or text message individualization according to the present disclosure.

FIG. 4 is an illustrative embodiment of a system for email or text message individualization according to the present disclosure showing an email individualized to one of the recipients.

FIG. 5 is an illustrative embodiment of a system for email or text message individualization according to the present disclosure showing a second an email individualized to each of two recipients.

FIG. 6 is an illustrative embodiment of a system for email or text message private commenting according to the present disclosure showing an email having a private comment directed to one of the recipients.

FIG. 7 is an illustrative embodiment of a system for email or text message individualization and private commenting according to the present disclosure showing an email individualized to two of the recipients and having a private comment directed to another of the recipients.

FIG. 8 is an illustrative embodiment of a system for email or text message individualization according to the present disclosure showing an individualized email received by one of the recipients.

FIG. 9 is an illustrative embodiment of a system for email or text message private commenting according to the present disclosure showing an email having a private comment received by one of the recipients.

FIG. 10 is a method of email or text message individualization and/or private commenting, according to one embodiment of the present disclosure.

### DETAILED DESCRIPTION

The present disclosure relates to novel and advantageous systems and methods for email, text messages, and the like, and particularly relates to systems and methods for mass email and text message text individualization and email and text message private commenting. More particularly, the present disclosure relates to novel and advantageous systems and methods for mass email and text message text individualization and email and text message private commenting, wherein text of a single email or text message can be directed to, personalized for, specialized for, or otherwise individualized for each recipient. Although the terms “individualization” and “private commenting” are used generally herein to describe separate concepts, the term “individualization” can also be construed as broad enough to cover “private commenting,” as private commenting is a type of individualization.

Emails and text messages have become a dominant form of communication. Oftentimes, it may be desirable to create or forward an email or text message to one or more recipients. Presently, an identical email or text is sent to each recipient on each of the “to,” “cc,” and “bcc” address lines. The various embodiments of the present disclosure provide systems and methods for individualizing the email to one or more of the addressees or one or more subsets of the addressees by allowing the sender to create individualized email or text message text that is added or associated with to the main body of the email, upon being sent, for only those addressees that are associated with the individualized email or text message text.

Similarly, oftentimes, it can be desirable to create or forward an email or text message to a recipient or recipients and to add a comment or remark to the created or forwarded email or text message. However, in many instances, it may not be desirable for the comment or remark to remain or become part of the created or forwarded email or text or otherwise become part of any saved record. The various embodiments of the present disclosure relate to systems and methods by which an email or text message may be created or forwarded to a recipient or recipients wherein a comment or remark directed to the recipient or recipients of the message or text generally does not become part of the created or forwarded message, and in some embodiments, may not generally become part of any organized record. Particularly, the various embodiments of the present disclosure relate to systems and methods by which an email or text message may be created or forwarded to a recipient or recipients wherein the sender can control whether a comment or remark directed to the recipient or recipients of the message or text can become part, or saved as part, of the created or forwarded message or any other organized record. In further embodiments, and in some cases only if allowed by the sender, the recipient of the comment may opt to save the comment or remark, separately or in combination with the created or forwarded message. In further embodiments yet, the sender of the comment may be provided with the option to select whether to allow or disallow the option of a recipient of the comment to save the comment or remark.

### Example Computing Environment

Aspects of the various embodiments of the present disclosure are suitable for use in a variety of computing system environments. In some computing environments, tasks may be performed by remote computer devices that are linked through communications networks. Embodiments of the present disclosure may comprise special purpose and/or general purpose computer devices that each may include specialized and/or standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, network PCS, minicomputers, mainframe computers, and the like. The various embodiments of the present disclosure may also be practiced in distributed computing environments where tasks are performed by remote processing devices that are linked through a communications network. In a distributed computing environment, program modules may be located in both local and remote memory storage devices.

The various embodiments of the present disclosure may be described in the general context of computer-executable instructions, such as program modules, that are executed by a personal computer or a server. Generally, program modules include routines, programs, objects, components, data structures, etc., that perform particular tasks or implement particular abstract data types. Typically, the functionality of the program modules may be combined or distributed as desired in various environments.

Embodiments within the scope of the present disclosure may also include computer readable media having executable instructions. Such computer readable media can be any available media, which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above are also included within the scope of computer readable media. Executable instructions can comprise, for example, instructions and data which cause a general purpose computer, special purpose computer, or general or special purpose processing device to perform a certain function or group of functions.

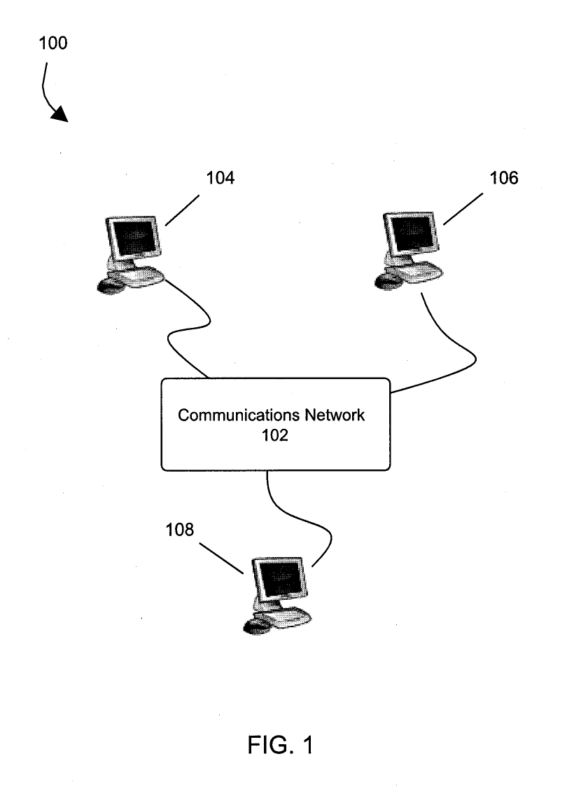

FIG. 1 illustrates an example of a suitable computing system operating environment 100 in which the various embodiments of the present disclosure may be implemented. Computing system operating environment 100 is only one example of a suitable operating environment and is not intended to suggest any limitation as to the scope of use or functionality of the embodiments of the present disclosure. Environment 100 is shown as including a communications network 102. The specific network implementation used can be comprised of, for example, any type of local area network (LAN) and associated LAN topologies and protocols; simple point-to-point networks (such as direct modem-to-modem connection); and wide area network (WAN) implementations, including public Internets and commercial based network services. Systems may also include more than one communication network, such as a LAN coupled to the Internet.

Computer device 104, computer device 106, and computer device 108 may be coupled to communications network 102 through communication devices. Network interfaces or adapters may be used to connect computer devices 104, 106, and 108 to a LAN. When communications network 102 includes a WAN, modems or other means for establishing communications over WANs may be utilized. Computer devices 104, 106, and 108 may communicate with one another via communication network 102 in ways that are well known in the art. The existence of any of various well-known protocols, such as TCP/IP, Ethernet, FTP, HTTP and the like, is presumed.

Computer devices 104, 106, and 108 may exchange content, applications, messages, and other objects via communications network 102. In some aspects of the various embodiments of the present disclosure, computer device 108 may be implemented with a server computer or server farm. Computer device 108 may also be configured to provide services to computer devices 104 and 106. Alternatively, computer devices 104, 106, and 108 may also be arranged in a peer-to-peer arrangement in which, for a given operation, ad-hoc relationships among the computing devices may be formed.

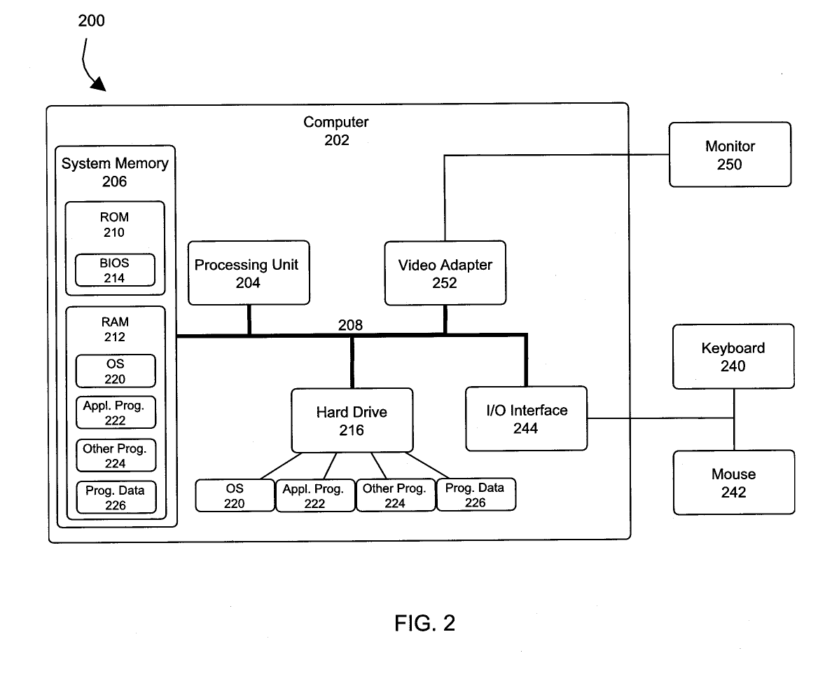

With reference to FIG. 2, an example of a suitable computing system 200, such as computer device 104, 106, or 108, for implementing the various aspects of the embodiments of the present disclosure may include a special purpose or general purpose computer 202, including a processing unit 204, a system memory 206, and a system bus 208 that couples various system components, including the system memory 206, to the processing unit 204. The processing unit 204 may be any commercially available or proprietary processor. In addition, the processing unit 204 may be implemented as multi-processor formed of more than one processor or processing cores, such as may be connected in parallel.

The system bus 208 may be any of several types of bus structure including a memory bus or memory controller, a peripheral bus, and a local bus using any of a variety of conventional bus architectures such as PCI, VESA, Microchannel, ISA, and EISA, to name a few. The system memory 206 may include read only memory (ROM) 210 and random access memory (RAM) 212. A basic input/output system (BIOS) 214, containing the basic routines that help to transfer information between elements within the computer 202, such as during start-up, may be stored in ROM 210.

The computer 202 also may include, for example, a hard disk drive 216, a magnetic disk drive, e.g., to read from or write to a removable disk, and/or an optical disk drive, e.g., for reading from or writing to a CD-ROM disk, DVD-ROM disk, or other optical media, or other suitable storage device. The hard disk drive 216, magnetic disk drive, and/or optical disk drive may be connected to the system bus 208 by a hard disk drive interface, a magnetic disk drive interface, and/or an optical drive interface, respectively. The drives and their associated computer-readable media may provide nonvolatile storage of data, data structures, computer-executable instructions, etc. for the computer 202. Although the description of computer-readable media above refers to a hard disk, a removable magnetic disk, and a CD or DVD, it should be appreciated by those skilled in the art that other types of media which are readable by a computer, such as magnetic cassettes, flash memory cards, digital video disks, Bernoulli cartridges, and the like, can also be used in the example computing system 200, and further that any such media may contain computer-executable instructions for performing the methods of the present disclosure.

A number of program modules can be stored in the drives, such as hard disk drive 216, and RAM 212, including an operating system 220, one or more application programs 222, other program modules 224, and program data 226. The operating system 220 can be any suitable operating system or combination of operating systems. By way of example only, the application programs 222 and program modules 224 can include an object management system that includes executable instructions for implementing a GUI according to an aspect of the various embodiments of the present disclosure. Additionally, by way of example only, the program data 226 can include input image data that can be used to populate the GUI with graphical objects.

A user can enter commands and information into the computer 202 through one or more user input devices, such as a keyboard 240 and/or a pointing device 242 (e.g., a mouse, a touch screen, a touch pad, and the like). Other input devices may include a microphone, a joystick, game pad, a satellite dish, wireless remote, a scanner, or the like. These and other input devices are often connected to the processing unit 204 through an I/O interface 244 that is coupled to the system bus 208. Those skilled in the art will understand and appreciate various other types of interfaces that can be used to connect such devices, including, for example, a parallel port, a game port, a universal serial bus (USB) hub and the like.

A monitor 250 or other type of display device may be connected to the system bus 208 via an interface, such as a video adapter 252. The computer 202 can also include other peripheral output devices, such as speakers, printers, etc. Those skilled in the art will understand how the computer can send data to such devices based on the description contained herein.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and/or a computer. By way of illustration, an application running on a server and/or the server can be a component. In addition, a component may include one or more subcomponents.

In accordance with the practices of persons skilled in the art of computer programming, the present invention has been described with reference to acts and symbolic representations of operations that are performed by a computer, such as the computer 202 or a remote computer, unless otherwise indicated. Such acts and operations are sometimes referred to as being computer-executed. It will be appreciated that the acts and symbolically represented operations may include the manipulation by the processing unit 204 of electrical signals representing data bits which causes a resulting transformation or reduction of the electrical signal representation, and the maintenance of data bits at memory locations in the memory system (including the system memory 206, hard drive 216, floppy disks, CD-ROM or DVD-ROM, and/or remote memory) to thereby reconfigure or otherwise alter the computer system's operation, as well as other processing of signals. The memory locations where such data bits are maintained may be physical locations that have particular electrical, magnetic, or optical properties corresponding to the data bits.

Where not discussed with specificity in this application, the systems and methods related to email and text messaging may be the same or generally similar to present email and text messaging systems and methods as will be understood by those skilled in the art.

Mass Email/Text Message Individualization and/or Email/Text Message Private Commenting

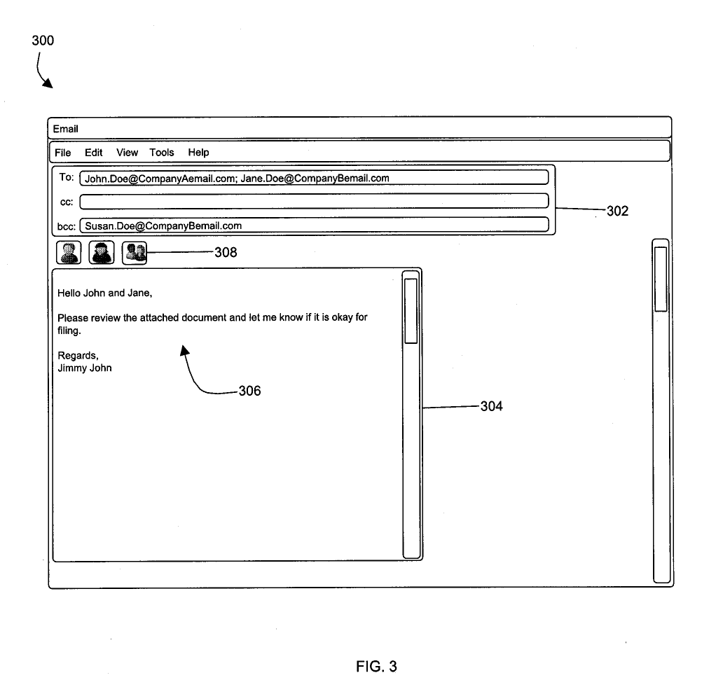

FIG. 3 generally illustrates an example sender interface 300 of a system for email or text message individualization and/or private commenting. The sender interface may include an addressee block 302 having input locations for entering recipient email or text message addresses. The addressee block 302 may include “To,” “cc,” and “bcc” addressee input locations. The sender interface 300 may also include an input window 304, or location, for entering in text 306 for the main body of the email or text message. The text 306 of the main body of the email or text message may include the portion of the email or text message that is sent to each recipient of the email or text message listed in the addressee block 302.

The sender interface 300 may also include one or more options or buttons 308 for creating, opening, or starting a new window, area, or location, for individualizing an email or text message for one or more particular recipients or subset of recipients and/or for creating, opening, or starting a new window, area, or location, for adding or creating a private comment or remark directed to one or more particular recipients or subset of recipients. In other embodiments, the new windows, areas, or locations may be opened from the menu bar or by any other suitable manner, as will be recognized by those skilled in the art. While not limited to the example embodiments described herein, email or text message text individualization and private commenting are described in further detail below with respect to various suitable embodiments.

The sender interface 300 may further include any standard or other suitable interface components, such as a menu bar, scroll bar, or the like. The sender interface 300 illustrated in the figures is for illustration purposes only, various modifications to the interface are recognized and are within the spirit and scope of the present disclosure.

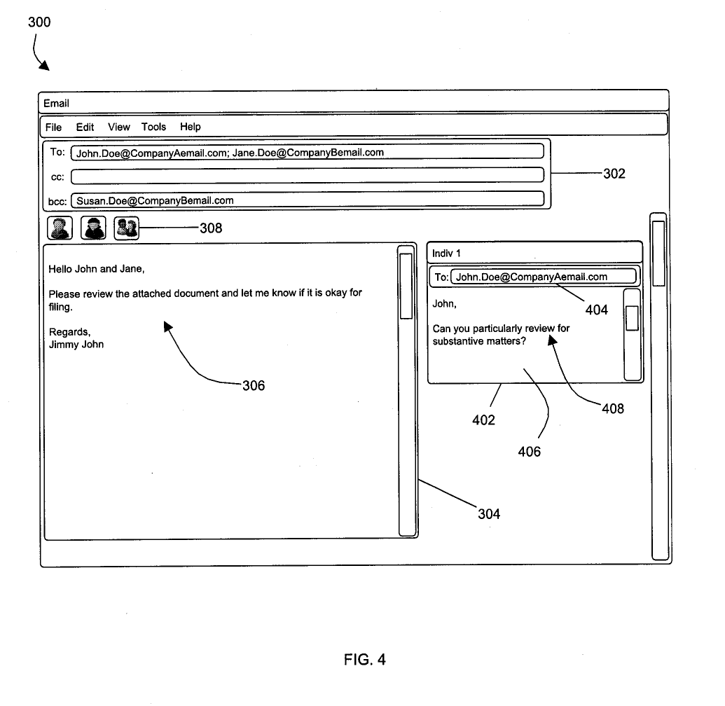

FIG. 4 illustrates an example sender interface 400 of a system for email or text message individualization and/or private commenting illustrating a window 402, area, or input location, for individualizing an email or text message for one or more particular recipients or subset of recipients. The window 402 for individualizing an email may include an addressee block 404 having input locations for entering recipient email or text message addresses. The addressee block 404 may generally include a “To” addressee input location. However, the addressee block may also include “cc” and “bcc” addressee input locations. Recipients may be added to the addressee block 404 by any suitable manner, including manually entry, drag-and-drop, selected from a drop-down menu, etc. The window 402 may also include an input area 406, or location, for entering in text 408 for the individualized portion of the email or text message. The text 408 of the individualized portion of the email or text message may be sent to only the addressees listed in the addressee block 404 of the window 402. In one embodiment, the text 408 of the individualized portion of the email or text message by be appended to, incorporated into, or otherwise added to or associated with the text 406 of the main body of the email or text message. Generally, in one embodiment, upon the email being sent to and received by the recipients of the email, the text 306 of the main body may be seen by all recipients listed in the addressee block 302, while only the recipients listed in the addressee block 404 of the window 402 will also see the individualized text 408 of the window 402.

In some embodiments, the recipients listed in the addressee block 404 may be a sub-portion of the recipients listed in the addressee block 302. In other embodiments, however, the recipients listed in the addressee block 404 may include recipients not listed in the addressee block 302. In one embodiment, the text 306 of the main body may be seen by all recipients listed in the addressee block 302, and the recipients listed in the addressee block 404 of the window 402 can see both the text 306 of the main body and the individualized text 408 of the window 402. In alternative embodiments, the text 306 of the main body may be seen by all recipients listed in the addressee block 302, and the recipients listed in the addressee block 404 of the window 402 may see only the individualized text 408 of the window 402. While in still further embodiments, the text 306 of the main body may be seen by all recipients listed in the addressee block 302, the recipients listed in both the address block 302 and the addressee block 404 of the window 402 may see both the text 306 of the main body and the individualized text 408 of the window 402, and the recipients only listed in the addressee block 404 but not the addressee block 302 may see only the text 408 of the window 402.

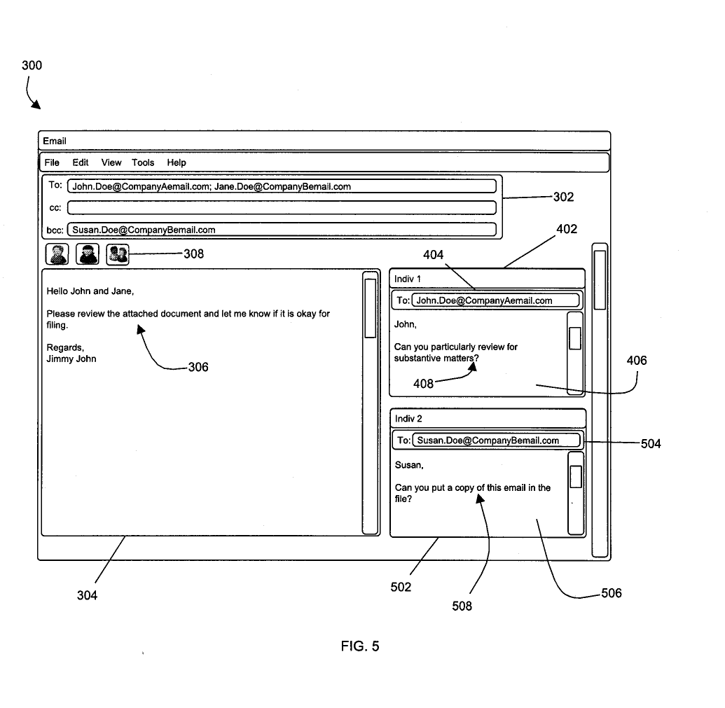

FIG. 5 illustrates an example sender interface 300 of a system for email or text message individualization and/or private commenting illustrating a second window 502, area, or input location, for individualizing an email or text message for one or more particular recipients or subset of recipients. The second window 502 for individualizing an email may be generally similar to the first window 402 and can include an addressee block 504 having input locations for entering recipient email or text message addresses. The recipients listed in the addressee block 504 of the second window may include none or one or more of the recipients of the addressee block 404 of the first window 402 or one or more other recipients or one or more subsets of other recipients. The addressee block 504 may generally include a “To” addressee input location. However, the addressee block may also include “cc” and “bcc” addressee input locations. Recipients may be added to the addressee block 504 by any suitable manner, including manually entry, drag-and-drop, selected from a drop-down menu, etc. The window 502 may also include an input area 506, or location, for entering in text 508 for the individualized portion of the email or text message. The text 508 of the individualized portion of the email or text message may be sent to only the addressees listed in the addressee block 504 of the window 502. In one embodiment, the text 508 of the individualized portion of the email or text message by be appended to, incorporated into, or otherwise added to or associated with the text 306 of the main body of the email or text message. Generally, in one embodiment, upon the email being sent to and received by the recipients of the email, the text 306 of the main body may be seen by all recipients listed in the addressee block 302, while only the recipients listed in the addressee block 504 of the window 502 will also see the individualized text 508 of the window 502.

As similarly described above, in some embodiments, the recipients listed in the addressee block 504 may be a sub-portion of the recipients listed in the addressee block 302. In other embodiments, however, the recipients listed in the addressee block 504 may include recipients not listed in the addressee block 302. In one embodiment, the text 306 of the main body may be seen by all recipients listed in the addressee block 302, and the recipients listed in the addressee block 504 of the window 502 can see both the text 306 of the main body and the individualized text 508 of the window 502. In alternative embodiments, the text 306 of the main body may be seen by all recipients listed in the addressee block 302, and the recipients listed in the addressee block 504 of the window 502 may see only the individualized text 508 of the window 502. While in still further embodiments, the text 306 of the main body may be seen by all recipients listed in the addressee block 302, the recipients listed in both the address block 302 and the addressee block 504 of the window 502 may see both the text 306 of the main body and the individualized text 508 of the window 502, and the recipients only listed in the addressee block 504 but not the addressee block 302 may see only the text 508 of the window 502.

Although illustrated with only first 402 and second 502 individualization windows, the sender interface 300 may allow any suitable number of individualization windows or areas. Generally, the addressees listed in the addressee blocks of the individualization windows will comprise addressees listed in the main addressee block 302. However, as described in detail above, it is recognized that some embodiments may allow the addressees listed in the addressee blocks of the individualization windows to comprise addressees other than those listed in the main addressee block 302.

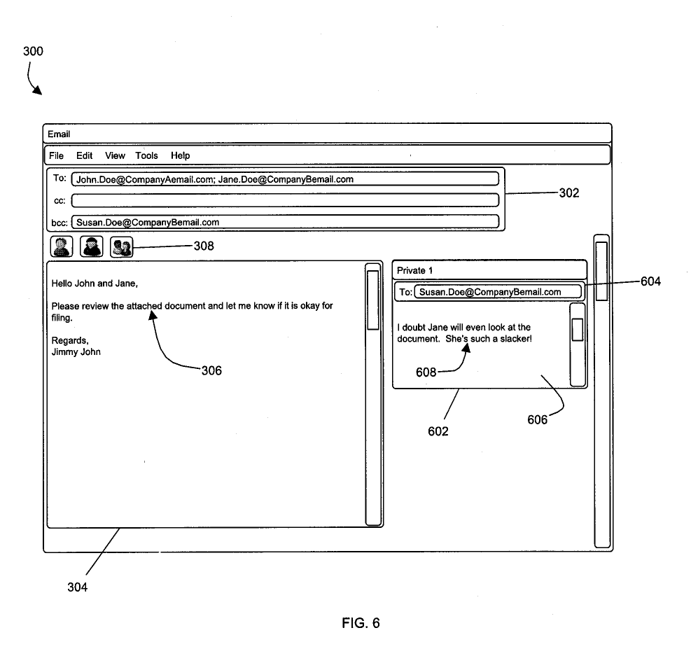

FIG. 6 illustrates an example sender interface 300 of a system for email or text message individualization and/or private commenting illustrating a window 602, area, or input location, for creating a private comment or remark directed to one or more particular recipients or subset of recipients. The window 602 for creating a private comment or remark may be generally similar to a window, or input location, for individualizing an email or text message and can include an addressee block 604 having input locations for entering recipient email or text message addresses. The addressee block 604 may generally include a “To” addressee input location. However, the addressee block may also include “cc” and “bcc” addressee input locations. Recipients may be added to the addressee block 604 by any suitable manner, including manually entry, drag-and-drop, selected from a drop-down menu, etc. The window 602 may also include an input area 606, or location, for entering in text 608 for the private comment or remark. The text 608 of the private comment or remark may be sent to only the addressees listed in the addressee block 604 of the window 602. Different from an individualized portion of an email or text message, described above, a private comment or remark, in one embodiment, may not become part of the email or text message. Rather, in one embodiment, the private comment or remark, upon the email being sent, may appear to the recipient in a pop-up window, as an instant message, or in another similar manner as will be recognized by those in the art. Generally, in one embodiment, upon the email being sent to and received by the recipients of the email, the text 306 of the main body may be seen by all recipients listed in the addressee block 302, while only the recipients listed in the addressee block 604 of the window 602 will also see the private comment or remark of the window 602. Generally, the pop-up window, instant message window, or the like may be closed, and in one embodiment, upon the window being closed, the private comment or remark may be deleted or otherwise no longer associated with the email or text message, and in some cases precluding the comment or remark from being part of any significant record. In some embodiments, and in some cases only if allowed by the sender, the recipient may be provided with the option to save the remark or comment, separately or in association with the email or text message. In further embodiments yet, the sender of the comment may be provided with the option to select whether to allow or disallow the option of a recipient of the comment to save the comment or remark.

In some embodiments, the recipients listed in the addressee block 604 may be a sub-portion of the recipients listed in the addressee block 302. In other embodiments, however, the recipients listed in the addressee block 604 may include recipients not listed in the addressee block 602. In one embodiment, the text 306 of the main body may be seen by all recipients listed in the addressee block 302, and the recipients listed in the addressee block 604 of the window 602 can see both the text 306 of the main body and the text 608 of the private comment or remark of the window 602. In alternative embodiments, the text 306 of the main body may be seen by all recipients listed in the addressee block 302, and the recipients listed in the addressee block 604 of the window 602 may see only text 608 of the private comment or remark of the window 602. While in still further embodiments, the text 306 of the main body may be seen by all recipients listed in the addressee block 302, the recipients listed in both the address block 302 and the addressee block 604 of the window 602 may see both the text 306 of the main body and text 608 of the private comment or remark of the window 602, and the recipients only listed in the addressee block 604 but not the addressee block 302 may see only text 608 of the window 602.

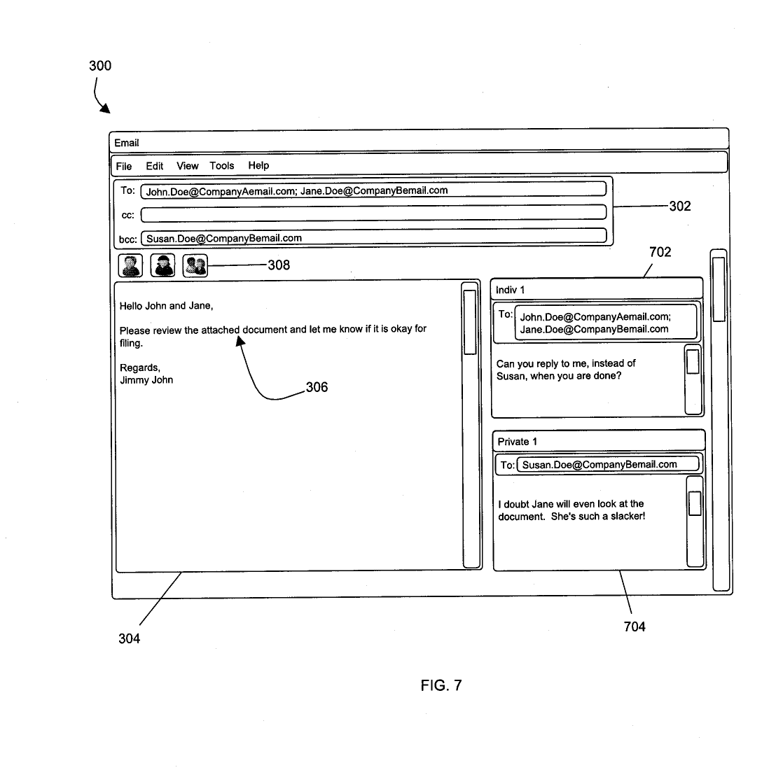

FIG. 7 illustrates an example sender interface 300 of a system for email or text message individualization and/or private commenting illustrating a first window 702, area, or input location, for individualizing an email or text message for one or more particular recipients or subset of recipients, as described above and a second window 704, area, or input location, for creating a private comment or remark directed to one or more particular recipients or subset of recipients, as described above. Although illustrated with only a first individualization window 702 and a second private commenting window 704, the sender interface 300 may allow any suitable number and combination of individualization and/or private commenting windows. Generally, the addressees listed in the addressee blocks of the individualization and/or private commenting windows will comprise addressees listed in the main addressee block 302. However, as described in detail above, it is recognized that some embodiments may allow the addressees listed in the addressee blocks of the individualization and/or private commenting windows to comprise addressees other than those listed in the main addressee block 302.

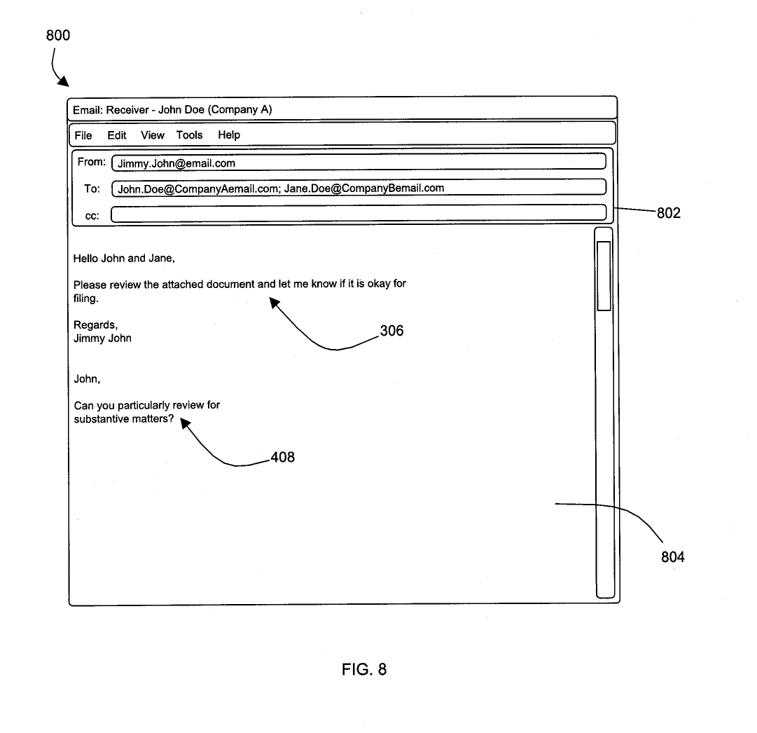

FIG. 8 generally illustrates an example recipient interface 800 of a system for email or text message individualization and/or private commenting. The recipient interface 800 may include an addressee block 802 indicating the addressees of the email or text message addresses. The addressee block 802 may indicate the addresses that were initially listed in the “To” and “cc” addressee input locations; however, the addressees listed in the “bcc” addressee input location may not be visible to one or more recipients. The recipient interface 800 may also include a text window 804, or location, for displaying the text 306 for the main body of the email or text message sent by the sender. The text 306 of the main body of the email or text message may include the portion of the email or text message that is sent to each recipient of the email or text message listed in the addressee block 302. The text window 804 for recipients also listed by the sender in an individualization window, such as window 402 of FIG. 4, may also include text from the individualization window. For example, as illustrated in FIG. 8, with respect to the email or text message of FIG. 4, in the received email or text message for John Doe, the text window may include the text of the main body of the email or text message, i.e., “Hello John and Jane, Please review the attached document and let me know if it is okay for filing. Regards, Jimmy John,” and may also include the text 408 of the individualized portion of the email or text message addressed to John Doe from window 402, i.e., “John, Can you particularly review for substantive matters?” Other recipients of the same email or text message may see the text of the main body of the email or text message; however, those recipients would not see the text from the individualized portion of the email or text message addressed to John Doe.

While illustrated as appended to the end of the text of the main body, the text from the individualized portion may be appended to any suitable portion of the main body or presented in any other suitable manner, such as but not limited to, in a new window.

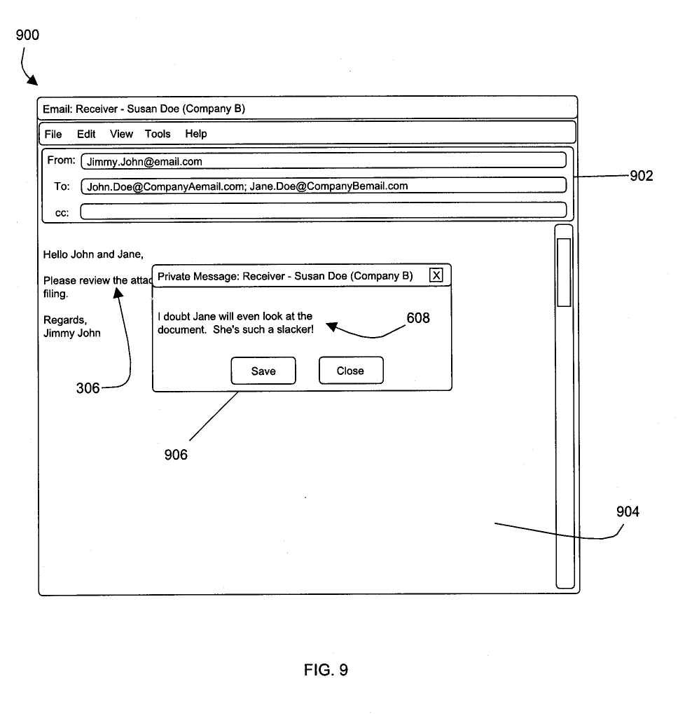

FIG. 9 generally illustrates an example recipient interface 900 of a system for email or text message individualization and/or private commenting. Similar to the recipient interface 800 of FIG. 8, the recipient interface 900 may include an addressee block 902 indicating the addressees of the email or text message addresses. The addressee block 902 may indicate the addresses that were initially listed in the “To” and “cc” addressee input locations; however, the addressees listed in the “bcc” addressee input location may not be visible to one or more recipients. The recipient interface 900 may also include an text window 904, or location, for displaying the text 306 for the main body of the email or text message sent by the sender. The text 306 of the main body of the email or text message may include the portion of the email or text message that is sent to each recipient of the email or text message listed in the addressee block 302.

In one embodiment, the private comment or remark, upon the email being received by the recipient, may appear to the recipient in a pop-up window, as an instant message, or other similar manner as will be recognized by those in the art. Generally, in one embodiment, upon the email being sent to and received by the recipients of the email, only the recipients listed in the addressee block of the window having the private comment or remark will see the private comment or remark. Generally, the pop-up window, instant message window, or the like may be closed, and in one embodiment, upon the window being closed, the private comment or remark may be deleted or otherwise no longer associated with the email or text message, and in some cases precluding the comment or remark from being part of any significant record. In some embodiments, and in some cases only if allowed by the sender, the recipient may be provided with the option to save the remark or comment. In further embodiments, the sender of the comment may be provided with the option to select whether to allow or disallow the option of a recipient of the comment to save the comment or remark. For example, as illustrated in FIG. 9, with respect to the email or text message of FIG. 6, in the received email or text message for Susan Doe, the text window may include the text of the main body of the email or text message, i.e., “Hello John and Jane, Please review the attached document and let me know if it is okay for filing. Regards, Jimmy John.” A pop-up window, instant message window, or the like 906 may include the text 608 of the private comment or remark addressed to Susan Doe from window 602, i.e., “I doubt Jane will even look at the document. She's such a slacker!” Other recipients of the same email or text message may see the text of the main body of the email or text message; however, those recipients would not see the text from the private comment or remark addressed to Susan Doe.

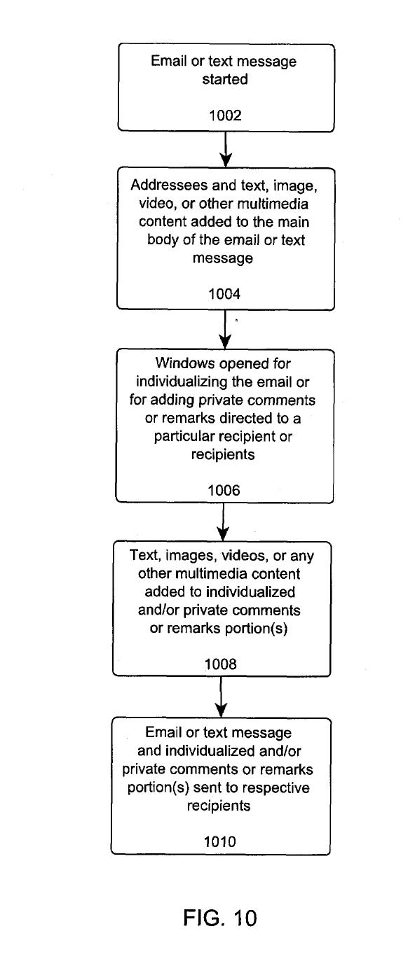

The various embodiments of mass email and text message text individualization and/or email and text message private commenting described herein may generally be used in the following manner, as shown in FIG. 10. The example method of FIG. 10 is provided for illustrative purposes only and is not meant to be limiting in any manner, such as with regards to the order of the steps. In step 1002, an email or text message may be started in generally a similar manner to current email systems. In step 1004, addressees can be listed in the addressee block of the email or text message and text, image, video, or other multimedia content may be added to the main body of the email or text message. Additionally, in step 1006, any number of windows may be opened, for example using GUI buttons, from the file menu, etc., for individualizing the email to a particular recipient or recipients or for adding private comments or remarks directed to a particular recipient or recipients. The individualized portion(s) of the email or text message and/or the private comments or remarks may include text, images, videos, or any other multimedia content, as shown in step 1008. When the email or text message and all individualized portions and/or private comments are completed, the email or text message may be sent in a similar manner as done by current email or text message systems, as shown in 1010. In one embodiment, the various embodiments of the present disclosure may include software and/or hardware, local to computing system 200 and/or remote from computing system 200, for determining which recipients of the email or text message receive the main body of the text, which receive one or more individualized portion of the email or text message, and/or which receive one or more private comments or remarks. In one embodiment, once it is determined which recipients receive which portions, the software and/or hardware may create an email for each individual with the correct portions. For example, each of the recipients listed in the addressee block associated with the main email or text message may receive the text, image, video, or other multimedia content of the main body of the email or text message. Any recipient also listed in the addressee block of one or more individualized portions of the email or text message may further receive the text, image, video, or other multimedia content of the respective individualized portions of the email or text message. Similarly, recipient also listed in the addressee block of one or more private comments or remarks of the email or text message may further receive the text, image, video, or other multimedia content of the respective private comments or remarks of the email or text message. The text, images, videos, or other multimedia content of an email or text message that comprises text, images, videos, or other multimedia content of the main body combined with text, images, videos, or other multimedia content of one or more individualized portions and/or private comments or remarks may be organized in any suitable, appealing, or fanciful manner, such that the organization of the combined email or text message can be understood by the recipient. The creation of individual emails for each recipient in most embodiments will not be transparent to the sender of the message. In other embodiments, any suitable method of preparing and sending the correct portions of the email or text message to each recipient may be used.

The various embodiments of mass email and text message text individualization and/or email and text message private commenting described herein can be developed using and/or may use one or more of any suitable programming languages, such as but not limited to, C, C++, Java, Perl, HTML, XML, etc. Additionally, the various embodiments of email and text message text individualization and/or private commenting described herein may be utilized or ran on any suitable computing environment and/or network (e.g., Internet), including but not limited to, personal computers, mobile telephones, mobile PCs, personal digital assistants (PDAs), etc.

Although the present invention has been described with reference to preferred embodiments, persons skilled in the art will recognize that changes may be made in form and detail without departing from the spirit and scope of the invention. For example, while generally discussed with respect to additional interface windows for adding an individualized email portion or a private comment or remark, it is recognized that any suitable manner of designating an area or areas for individualized portions and private comments or remarks may be used with departing from the spirit and scope of the present disclosure, and the area or areas are not limiting to only additional interface windows. For example, the individualized portions and private comments or remarks could be differentiated by text of a different color, font type, or font size, etc. Additionally, while generally discussed with respect to a main addressee block and additional addressee blocks for the individualized email portions and/or private comment and remark portions, any suitable manner of designating the respective addressees may be used without departing from the spirit and scope of the present disclosure.

1-14. (canceled)

15. A computer readable storage medium comprising computer program code for an email or text message system providing the capability for a single email or text message to be individualized to each of one or more of a plurality of recipients or one or more subsets of the plurality of recipients.

16. The computer readable storage medium of claim 15, wherein the computer program code provides that upon the email or text message being sent, a portion of the email or text message that is individualized to a recipient or subset of recipients is not seen by the other of the plurality of recipients.

17. The computer readable storage medium of claim 15, wherein the email or text message system comprises a user interface.

18. The computer readable storage medium of claim 17, wherein the user interface is configured to allow individualized portions for each of multiple recipients or subsets of recipients.

19. The computer readable storage medium of claim 15, wherein the email or text message is a forwarded email or text message.

20. A method for providing email or text message text individualization, the method comprising:
providing a computer interface for individualizing at least a portion of an email or text message for a particular recipient or subset of recipients of a plurality of recipients.

21. The method of claim 20, further comprising:
sending the email or text message to the plurality of recipients;
wherein the individualized portion of the email or text message is not delivered or is made substantially invisible to the recipients that are not the particular recipient or part of the subset of recipients.

22. The method of claim 20, wherein the computer interface is configured to allow individualized portions for each of multiple recipients or subsets of recipients of the plurality of recipients.

23. The method of claim 21, wherein, for the particular recipient or subset of recipients, the individualized portion of the email or text message is appended to a general portion of the email or text message being sent to the plurality of recipients.

24. The method of claim 21, wherein the email or text message is a forwarded email or text message.

25. A method for private commenting on an email or text message, the method comprising:
providing a computer interface for adding a comment or remark to an email or text message that is associated with the email or text message but generally is not part of the email or text message.

26. The method of claim 25, wherein the comment or remark can be individually directed to one or more recipients of a plurality of recipients of the email or text message.

27. The method of claim 26, further comprising:
sending the email or text message and the associated comment or remark to the one or more recipients of the plurality of recipients; and
deleting the association of the comment or remark with the email or text message after the one or more recipients have first opened or viewed the email or text message and the one or more recipients have had a chance to read the comment or remark.

28. The method of claim 25, wherein the email or text message is a forwarded email or text message.

29. The method of claim 25, wherein the comment or remark is generally in the form of an instant message.

30. The method of claim 26, further comprising deleting the comment or remark after the email or text message is first opened or viewed by the one or more recipients and the one or more recipients have had a chance to read the comment or remark.

31. The method of claim 26, further comprising allowing the comment or remark to be saved by each of the one or more recipients.

32. The method of claim 27, further comprising allowing the comment or remark to be saved by each of the one or more recipients.

33. The method of claim 31, further comprising allowing each of the one or more recipients to associate the comment or remark with the email or text message.

34. The method of claim 26, further comprising blocking the one or more recipients from saving the comment or remark.
